(19) United States
(12) Patent Application Publication
(10) Pub. No.: US 2024/0398658 A1
(43) Pub. Date: Dec. 5, 2024

(54) Multi-function mobility staff for massage therapy and rehabilitation exercises

(71) Applicant: Todd Plutchock, San Diego, CA (US)

(72) Inventor: Todd Plutchock, San Diego, CA (US)

(21) Appl. No.: 18/204,195

(22) Filed: May 31, 2023

(51) Int. Cl. A61H 15/00

(52) U.S. Cl. CPC A61H 15/00; A61H 2015/0014; A61H 2015/005; A61H 2201/1685; A63B 21/00178

(57) ABSTRACT

Disclosed is an innovative and versatile device that combines the benefits of therapeutic massage therapy and rehabilitation exercises. It addresses the limitations of existing massage therapy rollers, which are not suitable for rehabilitation purposes, and provides a comprehensive solution in a single device. The device is a staff and is preferably constructed as a hollow cylinder made of lightweight carbon fiber material. It consists of three main segments: a middle segment and two end segments. Each end segment features an end ball, an anchor, and a handle grip. The middle segment is designed to receive the pin heads of the end segments, allowing for secure attachment. The device incorporates various components, including roller balls, inner and outer handle grips, anchors, and retention rims. The roller balls are threaded onto the middle segment, and the inner handle grips can be placed over the ends of the middle segment. This configuration enables users to grip the inner or outer handle grips and roll the roller balls on their own body or someone else's body for massage therapy purposes. Additionally, the mobility staff can be used for rehabilitation exercises. The device offers stability, controlled movements, and targeted resistance, facilitating muscle activation, range of motion, and strength training. Users can perform exercises by gripping the handle grips, leveraging body weight, and engaging in controlled rolling movements against the ground or wall. The technology also includes features such as grommets for attaching straps, allowing users to perform various exercises and stretches. The versatility of the mobility staff makes it suitable for both personal use and professional settings, such as physical therapy clinics, fitness centers, and rehabilitation facilities.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter is in the field of combination of therapeutic devices and exercise equipment. The field encompasses the areas of massage therapy, rehabilitation, and mobility aids.

### Background of the Invention

Massage therapy is widely recognized for its therapeutic benefits in promoting relaxation, relieving muscle tension, and improving overall well-being. Various massage therapy devices, such as rollers, have been developed to target specific areas of the body and provide effective massage techniques. However, these devices are primarily designed for massage purposes and often lack the versatility to be utilized for rehabilitation exercises.

On the other hand, rehabilitation therapy focuses on restoring physical function, mobility, and strength in individuals recovering from injuries, surgeries, or other physical impairments. Rehabilitation exercises play a crucial role in the recovery process by promoting muscle activation, range of motion, and functional abilities. Unfortunately, existing massage therapy devices are not suitable for performing exercises in rehabilitation therapy. They lack the necessary features and functionality to provide targeted resistance, stability, and controlled movements required for effective rehabilitation exercises. This limitation has created a need for separate devices specifically designed for rehabilitation exercises, resulting in additional equipment and costs.

Recognizing the need for a comprehensive solution that combines both massage therapy and rehabilitation exercise functionalities, the present technology was developed. By integrating the benefits of both massage therapy and rehabilitation exercises into a single, novel device, this technology aims to provide a versatile and efficient tool for individuals seeking both therapeutic massage and rehabilitation training.

### SUMMARY OF THE INVENTION

The mobility staff disclosed herein offers a unique combination of features that enable users to seamlessly transition between massage therapy and rehabilitation exercises. The mobility staff is an innovative and versatile device that combines the benefits of therapeutic massage therapy and rehabilitation exercises. It addresses the limitations of existing massage therapy rollers, which are not suitable for rehabilitation purposes, and provides a comprehensive solution in a single device. The staff is preferably constructed as a hollow cylinder made of lightweight carbon fiber material or a combination of polyvinylchloride (PVC) and carbon fiber. It consists of three main segments: a middle segment and two end segments. Each end segment features an end ball, an anchor, and a handle grip. The middle segment is designed to receive the pin heads of the end segments, allowing for secure attachment. The device incorporates various components, including roller balls, inner and outer handle grips, anchors, and retention rims. The roller balls are threaded onto the middle segment, and the inner handle grips can be placed over the ends of the middle segment. This configuration enables users to grip the inner or outer handle grips and roll the roller balls on their own body or someone else's body for massage therapy purposes. Additionally, the mobility staff can be used for rehabilitation exercises. The device offers stability, controlled movements, and targeted resistance, facilitating muscle activation, range of motion, and strength training. Users can perform exercises by gripping the handle grips, leveraging body weight, and engaging in controlled rolling movements against the ground or wall. The technology also includes features such as grommets for attaching straps, allowing users to perform various exercises and stretches. The versatility of the mobility staff makes it suitable for both personal use and professional settings, such as physical therapy clinics, fitness centers, and rehabilitation facilities.

By combining massage therapy and rehabilitation exercise functionalities into a single device, the mobility staff offers convenience, cost-effectiveness, and efficiency. It eliminates the need for separate equipment, providing users with a comprehensive tool for achieving therapeutic massage and effective rehabilitation training. The mobility staff technology has the potential to revolutionize the field of therapeutic devices, offering individuals a versatile and integrated solution to address their massage therapy and rehabilitation exercise needs. The mobility staff serves as a versatile tool that integrates elements of massage therapy, exercise, and mobility assistance, providing a comprehensive solution for individuals seeking both therapeutic and rehabilitative benefits. It bridges the gap between traditional massage tools and rehabilitation exercise devices, offering a novel and multifunctional approach to addressing the needs of users in these fields.

### BRIEF DESCRIPTION OF THE SEVERAL VIEWS OF THE DRAWINGS

Other objectives of the disclosure will become apparent to those skilled in the art once the invention has been shown and described. The way these objectives and other desirable characteristics can be obtained is explained in the following description and attached figures in which:

FIG. 1 is a perspective view of a mobility staff;

FIG. 2 is a front view of the mobility staff of FIG. 1;

FIG. 3 is a rear view of the mobility staff of FIG. 1;

FIG. 4 is a right-side view of the mobility staff of FIG. 1;

FIG. 5 is a left side view of the mobility staff of FIG. 1;

FIG. 6 is a perspective view of the middle segment of the mobility staff of FIG. 1;

FIG. 6A is a side view of the middle segment shown in FIG. 6;

FIG. 6B is a zoom in of detail A of FIG. 6A;

FIG. 6C is a cross section of the middle segment shown in FIG. 6A along the line B-B in that figure;

FIG. 7 is a perspective view of a roller shown in FIG. 5;

FIG. 7A is a side view of the roller of FIG. 7;

FIG. 7B is a cross section of the roller of FIG. 7A along the line A-A of FIG. 7A;

FIG. 8A is a side vie of an inner handle grip shown in FIG. 5;

FIG. 8B is a cross section of the handle grip of FIG. 8A along the line A-A of FIG. 8A;

FIG. 8C is a zoom-in view of the detail B of FIG. 81;

FIG. 9A is a roller ball for the middle section or segment of the staff shown in FIG. 1;

FIG. 9B is a cross section of the roller ball of FIG. 9A along the line A-A of FIG. 9A;

FIG. 10A is a side view of an end cap ball for the end segment of the staff shown in FIG. 1;

FIG. 10B is a cross section of the end cap ball along the line A-A of FIG. 10A;

FIG. 10C is a bottom view of the end cap ball of FIG. 10A;

FIG. 10D is a zoom in of Detail B of FIG. 10B;

FIG. 11 is a perspective view of an end segment of the mobility staff shown in FIG. 1;

FIG. 11A is a side view of the end segment of the mobility staff shown in FIG. 11;

FIG. 11B is a cross section of the end segment of the mobility staff along the lines C-C of FIG. 11A;

FIG. 11C is a zoom in of detail A of FIG. 11A;

FIG. 11D is a zoom in of detail B of FIG. 11A;

FIG. 12 is an end cap that is provided within the end cap ball of FIG. 10;

FIG. 12A is a side view of the end cap of FIG. 12;

FIG. 12B is a cross section of the end cap of FIG. 12A taken on the line A-A of FIG. 12A;

FIG. 13A is a side view of a handle grip for the end segment of the mobility staff of FIG. 1;

FIG. 13B is a cross section of the handle grip of FIG. 13A along the line A-A of FIG. 13A;

FIG. 14 is a spring loaded pin of FIG. 1;

FIG. 14A is a front view of the spring loaded pin of FIG. 14;

FIG. 14B is a side view of the spring loaded pin of FIG. 14;

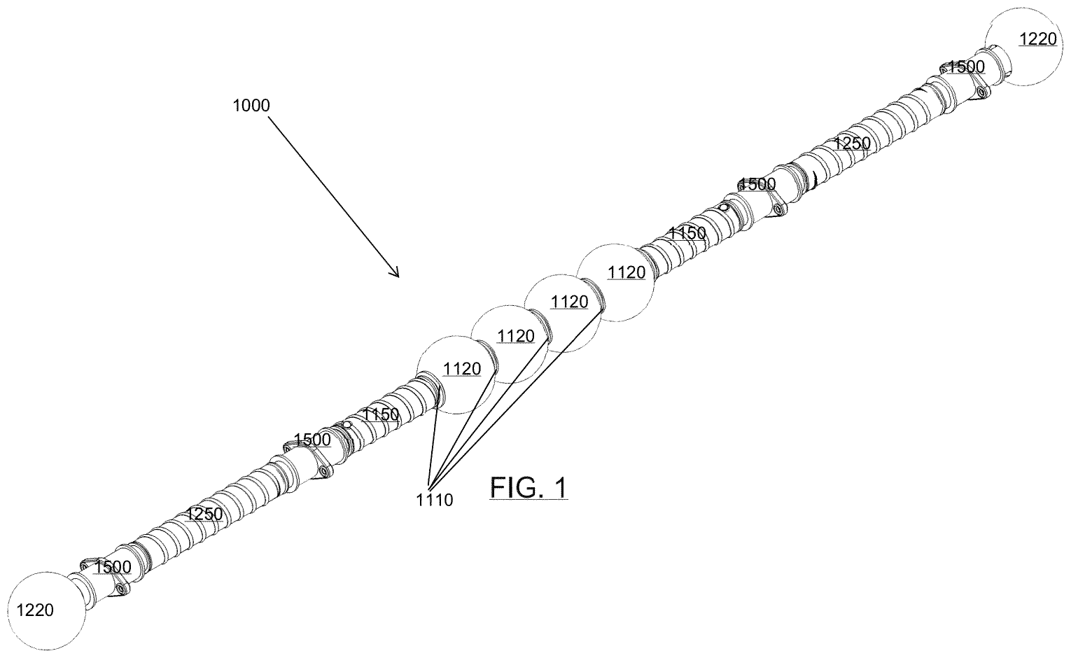

FIG. 0.15 is a perspective view of an anchor for the mobility staff of FIG. 1;

FIG. 15A is a front view of the anchor of FIG. 15; and,

FIG. 15B is a side view of the anchor of FIG. 15.

In the figures, the following reference numerals designate the corresponding parts:
Staff: 1000
   Middle Segment: 1100
      Roller: 1110
         Roller Retainer Ribs: 1111
      Roller Ball: 1120
      Handle Grip for the Middle Segment (inner handle grip): 1150
         Handle Retainer Rim: 1152
      Hole for Spring Loaded Pin: 1160
   End Segment: 1200
      End Ball: 1220
         Channels inside the End Ball: 1221
      Female Threads of the End Segment: 1230
      Pin Head of the End Segment: Where the pin is located on the tip: 1240
      Handle Grip for the End Segment (outer handle grip): 1250
         Handle Retainer Rim: 1251
      End Cap: 1260
         End Cap Ribs: 1261
         End Cap Female Threads: 1262
      Spring Loaded Pin: 1270
   Anchor: 1500
      Grommet for the Anchor: 1510

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed is a mobility staff that offers a unique combination of features that enable users to seamlessly transition between massage therapy and rehabilitation exercises. The incorporation of roller balls, handle grips, anchors for resistance bands and other components allows for targeted muscle massage while also facilitating controlled movements, resistance training, and stability during rehabilitation exercises. With this innovative technology, users can experience the benefits of therapeutic massage for relaxation and muscle relief, while also engaging in effective rehabilitation exercises to enhance mobility, strength, and overall physical well-being. By eliminating the need for separate devices, the mobility staff offers convenience, cost-effectiveness, and versatility in addressing both massage therapy and rehabilitation exercise needs. Basically, the mobility staff in a preferred embodiment is defined by: Middle Segment or the central section of the staff that connects the two end segments, wherein the middle segment is a hollow cylinder made of lightweight carbon fiber material; End Balls where one end of the staff features an end ball, and the other end also has an end ball and wherein such spherical components provide stability and facilitate gripping and maneuvering of the staff; Anchors that are located between the end balls and handle grips where the anchors help secure the components in place and provide structural support for the staff while providing a grommet for attachment of resistance bands to the staff; Handle Grips attached to each end segment of the staff where these grips provide a comfortable and secure hold for users during exercises or massage therapy sessions; and, Roller Balls on the middle segment of the staff where these spherical components are threaded onto the staff and can roll freely such that they facilitate smooth rolling movements during massage therapy or rehabilitation exercises. These components work together to create a functional and versatile mobility staff that combines the benefits of massage therapy and rehabilitation exercises. The more detailed aspects of the disclosed mobility staff are disclosed with reference to the attached figures.

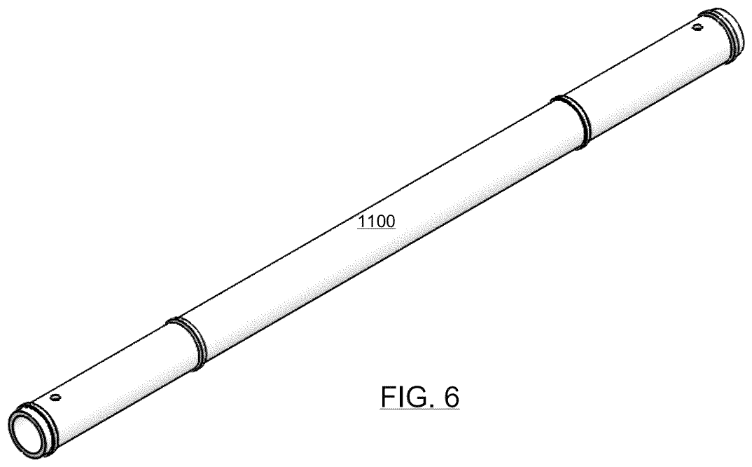

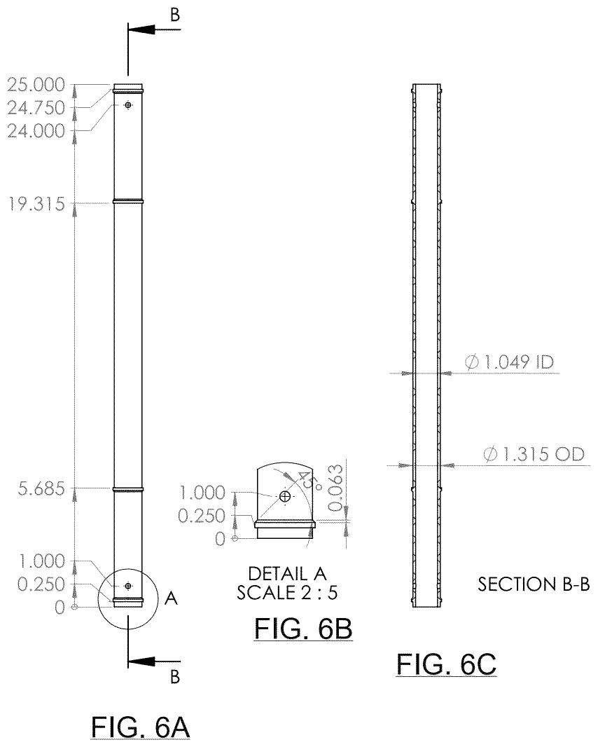

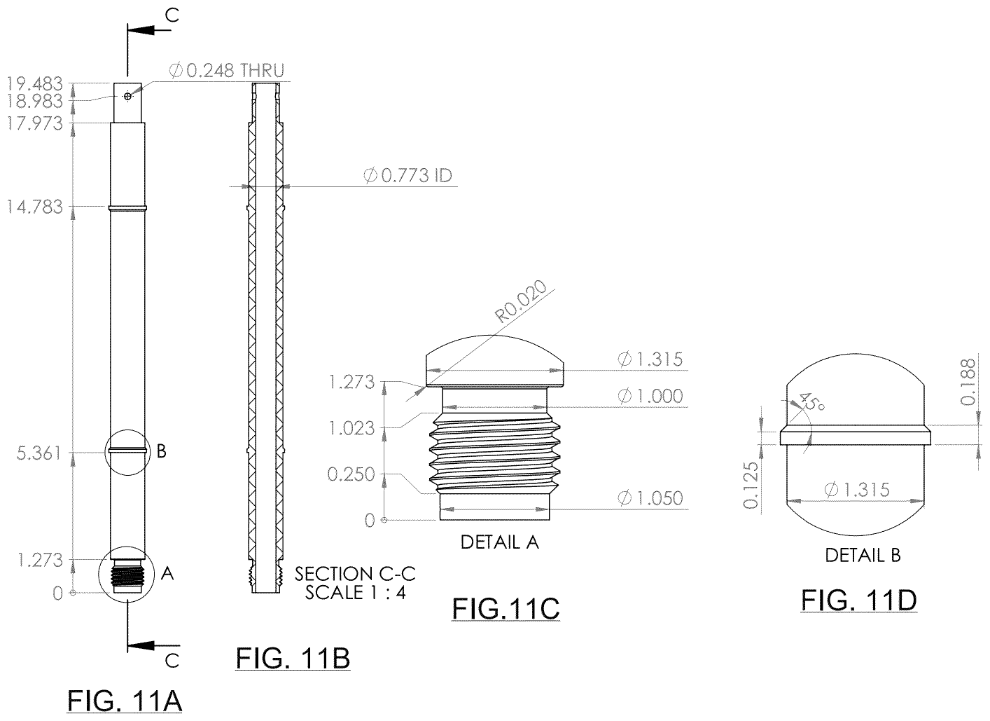

FIG. 1 illustrates a perspective view of the assembled mobility staff 1000, which consists of a hollow cylinder made of carbon fiber. The staff 1000 is designed to enhance mobility and provide support to the user during various activities. At one end of the staff 1000, an end ball 1220 is attached. The end ball 1200 can sometimes serves as a gripping point, a footer, a lever pivot point, or a massage point and helps in maintaining stability during use. Adjacent to the end ball 1200, an anchor 1500 is positioned, serving as a connection point for additional components. Following the anchor 1500, an end segment's handle grip 1250 is provided. The handle grip 1250 offers a comfortable grip for the user, enabling better control and maneuverability of the staff 1000. Another anchor 1500 is positioned after the handle grip 1250, allowing for further customization and attachment of additional elements. Next, an inner handle grip 1150 is placed, followed by four roller balls 1120. These roller balls 1120 are designed to roll smoothly on the user's body, providing massage or pressure therapy as desired. The roller balls 1120 are threaded onto the middle segment (see FIG. 6) of the staff, offering adjustability and easy interchangeability. Subsequently, another inner handle grip 1150 is included, followed by an anchor 1500 and the handle grip 1250 for the end segment (see FIG. 11). The handle grip 1250 for the end segment (see FIG. 11) provides a comfortable grip and control over the staff 1000 during use. Finally, at the far end of the staff 1000, another end ball 1220 is attached, serving as an additional a gripping point, a footer, a lever pivot point, or a massage point and helps in maintaining stability during use.

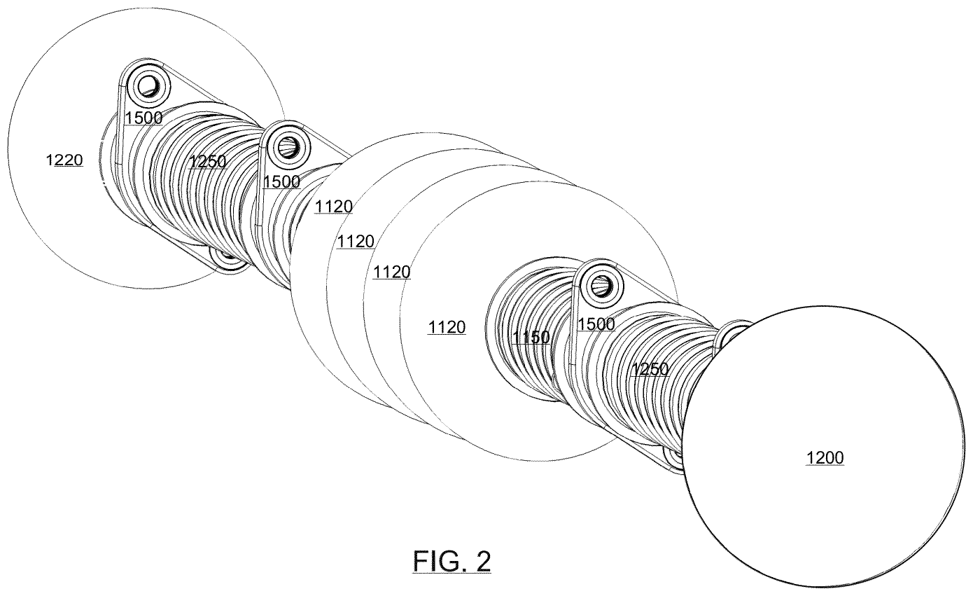

FIG. 2 depicts a front view of the assembled mobility staff 1000, showcasing its structural arrangement and components. As mentioned above, the staff is composed of a hollow cylindrical body (not shown) made from lightweight and durable carbon fiber material. The front view provides a clear visual representation of the various elements of the staff 1000. Starting from the left side, the figure shows the end balls 1220 securely attached to the staffs ends. Moving along the staffs 1000 body towards there exist the anchors 1500 providing a connection point for additional components and accessories (like resistance bands). The anchor allows for the secure attachment of various accessories, enhancing the versatility and functionality of the staff. Adjacent to the anchors, the handle grips 1250 for the end segment (see FIG. 11) is visible. This handle grip 1250 is designed to offer a firm and ergonomic grip, ensuring the user's comfort and control during use of the staff 1000. The handle grip 1250 is securely provided to the staff with helical ribs, providing stability and preventing any slippage. Towards the center of the staff 1000, the four roller balls 1120 are evenly spaced and visibly protrude from the staff's surface. These roller balls are threaded through onto the staff's middle segment (See FIG. 6), enabling smooth rolling and movement on the user's body for massage or pressure therapy. The rear view in FIG. 3 also demonstrates the arrangement and integration of the various components of the mobility staff 1000, highlighting the ergonomic design, versatility, and functionality it provides to the user.

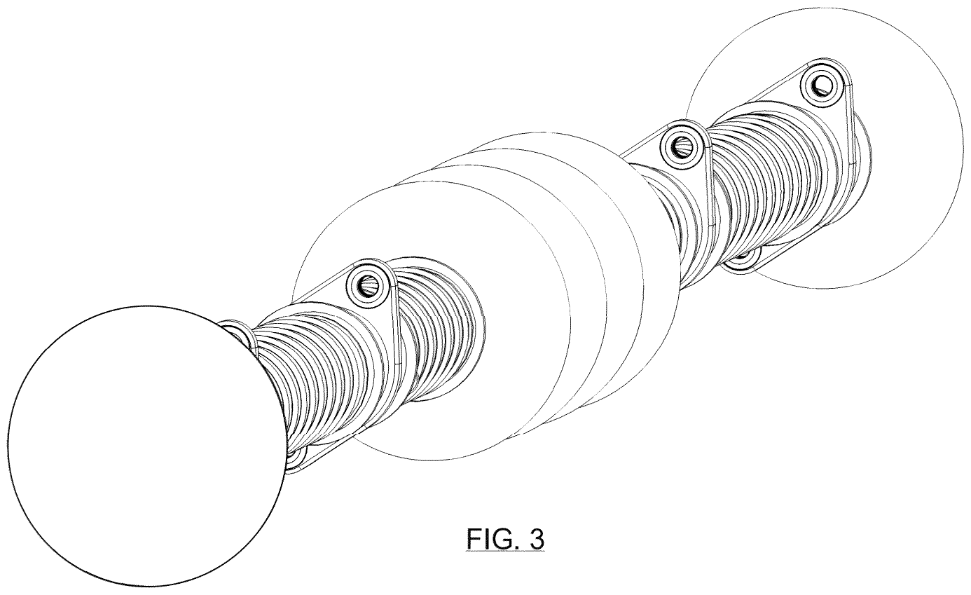

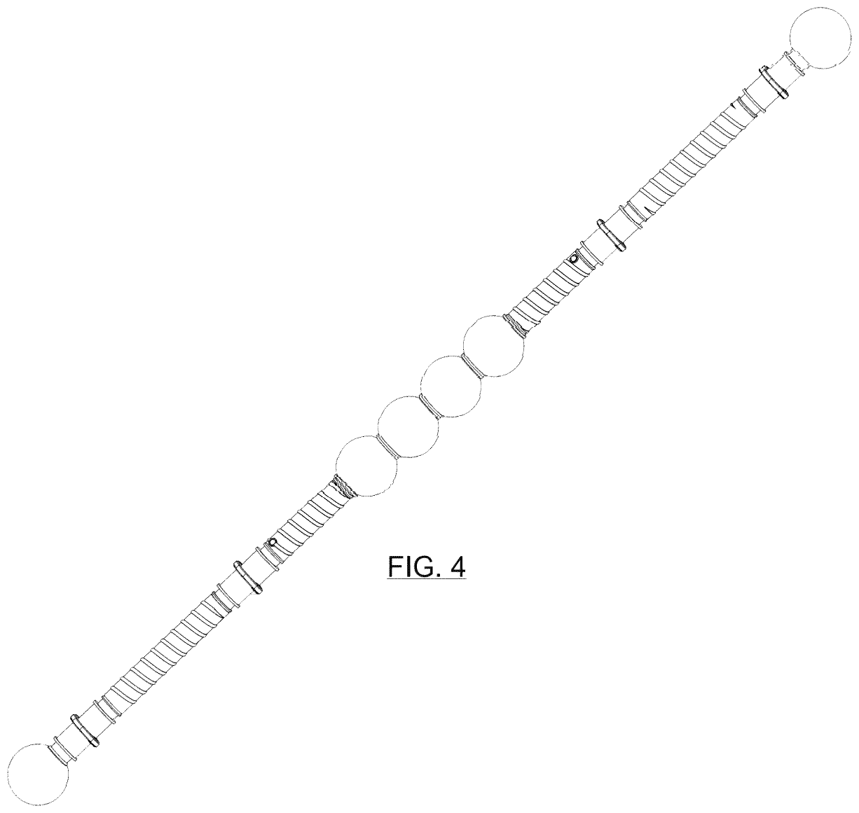

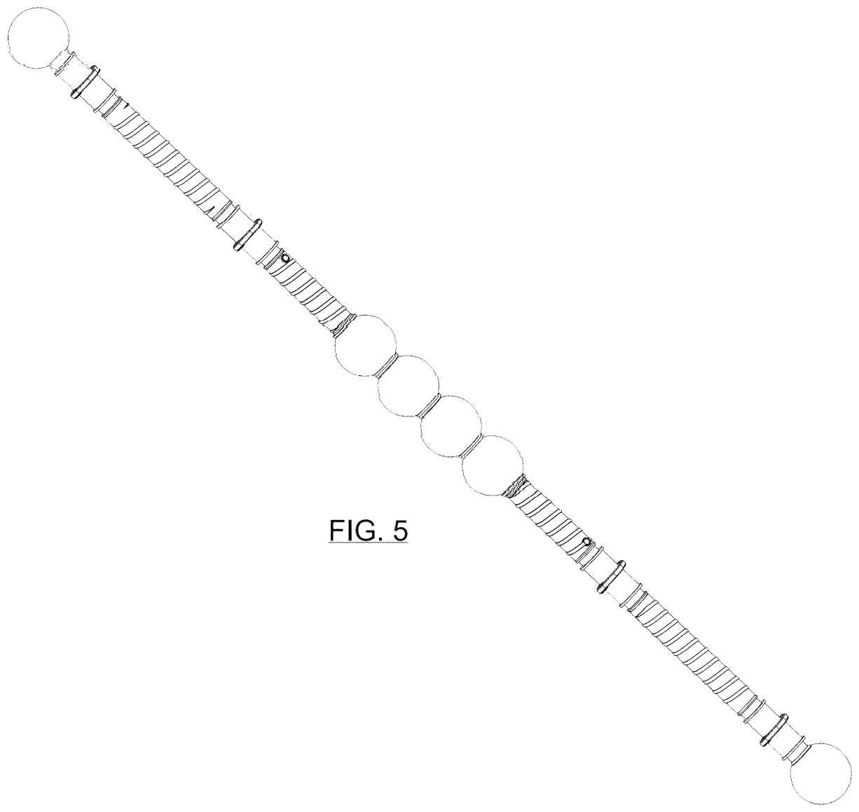

FIGS. 4 and 5 illustrate the side views of the assembled mobility staff, providing a comprehensive understanding of its overall structure and configuration from different perspectives. Both FIG. 4 and FIG. 5 emphasize the ergonomic design, symmetry, and versatility of the assembled mobility staff, providing users with a comfortable and functional tool for various applications.

Although the method and apparatus is described above in terms of various exemplary embodiments and implementations, it should be understood that the various features, aspects, and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

FIGS. 6, 6A, 68, and 6C collectively illustrate the middle segment 1100 of the mobility staff 1000, providing detailed views of its structure, features, and compatibility with various accessories. Starting with FIG. 6, which offers a perspective view, it presents the middle segment as a hollow cylinder, constructed using lightweight and robust carbon fiber material. The middle segment 1100 serves as the central component of the staff 1000, providing structural integrity and supporting the attachment of other elements. FIG. 6A, a side view of the middle segment 1100, showcases its cylindrical shape and smooth surface finish. The hollow interior of the middle segment allows for convenient threading and attachment of various accessories, such as roller balls 1120 (not shown) and handles 1150 (not shown). Zooming in on Detail A of FIG. 6A, as depicted in FIG. 68, we observe the cross-section of the middle segment 1100. It reveals the structure and features that facilitate the secure retention of the roller balls and the threading of accessories. Specifically, the figure demonstrates the presence of retention ribs around the middle segment. These retention ribs are strategically positioned to hold and retain the roller balls in place, preventing them from sliding or detaching during use. Moving to FIG. 6C, a cross-sectional view along the line B-B of FIG. 6A, it further highlights the internal configuration of the middle segment. The figure demonstrates the open hollow space within the middle segment, allowing for the insertion and threading of various accessories for instance, the pin head of the end segment (see FIG. 11). Additionally, it emphasizes the compatibility and alignment between the middle segment and the roller balls, ensuring smooth rolling functionality when the staff is in use. The combined information from FIG. 6, FIG. 6A. FIG. 6B, and FIG. 6C provides a comprehensive understanding of the middle segment of the mobility staff. Its hollow cylindrical design, construction materials, and internal features enable easy attachment, secure retention, and smooth functionality of accessories like roller balls and handles.

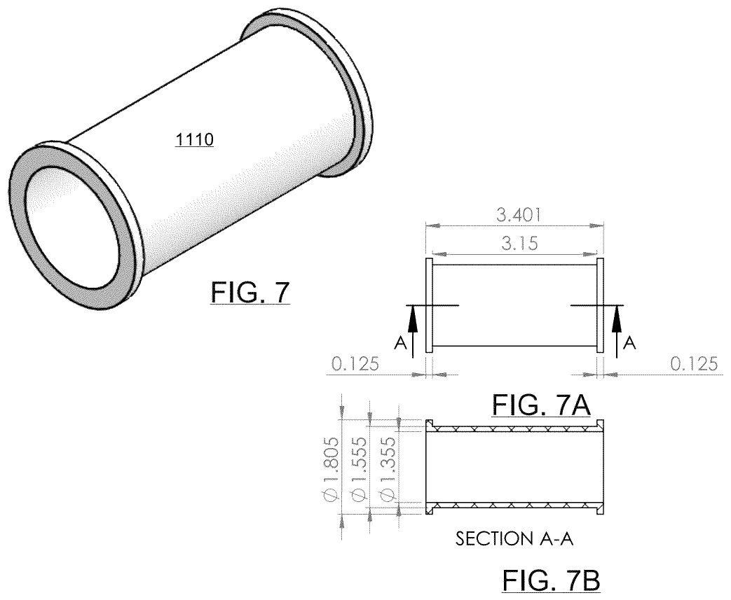

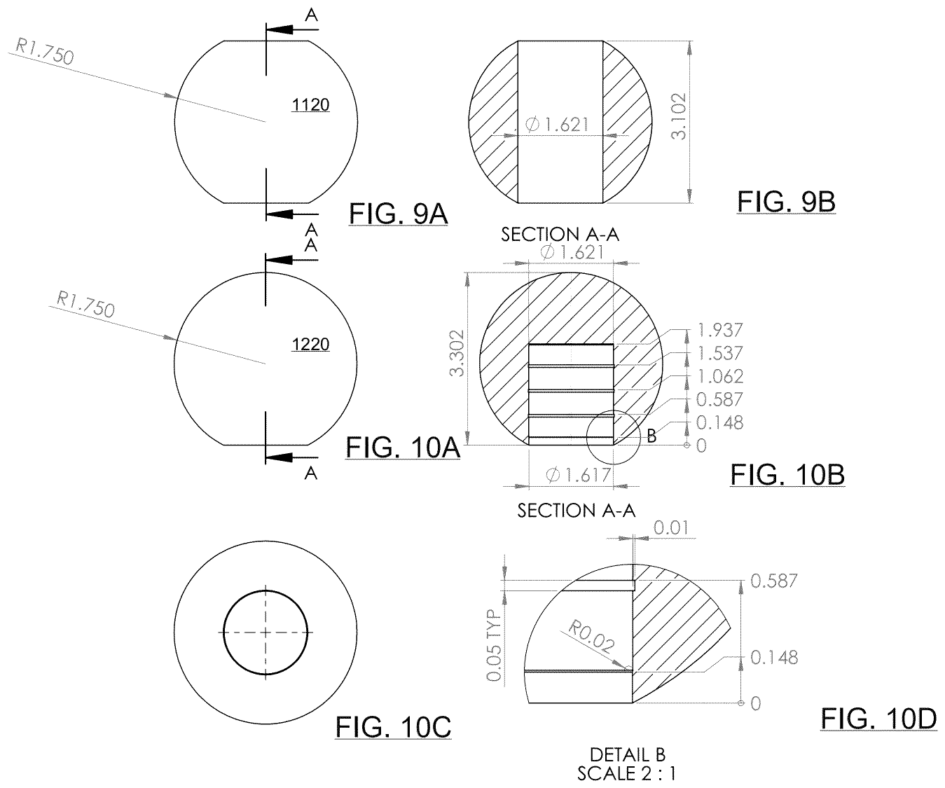

FIGS. 7, 7A, and 7B collectively depict the design and structure of the roller 1110 used in conjunction with the mobility staff. FIG. 9A and FIG. 9B showcase the roller ball 1120 designed for use in the middle segment 1100 of the mobility staff 1000. The roller ball 1120 is a key component that enables smooth and controlled movement of the staff during operation. Starting with FIG. 7, it presents a perspective view of the roller 1110. The roller features a cylindrical shape and is designed to be coaxially inserted into the roller balls 1120 of the middle segment 1100 of the staff 1000. It is constructed using a durable and lightweight material to ensure optimal functionality and longevity. The combination of the roller ball and the roller enables smooth rotation and movement of the staff. The roller is threaded through the central hole of the ball, allowing the ball to roll along the user's body during operation. This rolling motion provides therapeutic benefits and facilitates ease of movement.

Referring to FIG. 7A, which offers a side view of the roller, it provides a more detailed illustration of its design. The figure showcases the cylindrical shape and highlights the presence of rims located at both ends of the roller 1110. These rims serve as a means to retain the roller ball 1120 around the roller 1110, preventing the ball 1120 from sliding off during use. Zooming in on Detail A of FIG. 7A, as depicted in FIG. 7B, we can observe the cross-section of the roller 1110. The figure showcases the internal structure of the roller, specifically the configuration that allows for the coaxial insertion of the middle segment 1100. The roller is designed to securely accommodate the roller ball, ensuring smooth rotation and movement along the staff when in use. The combined information from FIG. 7, FIG. 7A, and FIG. 7B provides a comprehensive understanding of the roller used in the mobility staff. Its cylindrical design, inclusion of retaining rims, and compatibility with the roller balls of the middle segment ensure effective rolling functionality and contribute to the overall user experience.

FIG. 9A presents a side view of the roller ball 1120. The roller ball 1200 is a spherical object designed to be threaded by a roller 1110 and the middle segment 1100 of the staff. It is constructed from a durable and lightweight material such as plastic, rubber or metal to ensure longevity and ease of use. The size of the roller ball is specifically tailored to fit between the rims of the roller 1110. Moving to FIG. 9B, which offers a cross-section of the roller ball, it provides a more detailed illustration of its internal structure. The figure showcases the spherical shape of the ball and highlights the presence of a central hole that extends through the ball. This central hole is designed to accommodate a roller, which is cylindrical in shape and features rims on both ends. The rims ensure that the edges of the roller are held against the inner surface of the ball, securely keeping the ball attached to the roller. The information provided in FIG. 9A and FIG. 9B offers a comprehensive understanding of the roller ball used in the middle segment of the mobility staff. Its spherical shape, central hole, and compatibility with the roller contribute to the overall functionality and mobility of the staff.

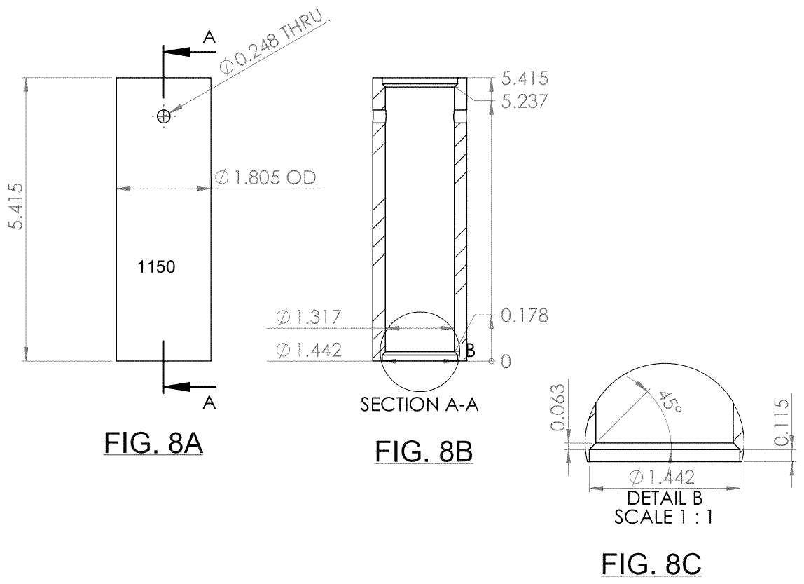

FIGS. 8A, 8B, and 8C collectively illustrate the design and structure of the inner handle grip 1150 used in conjunction with the middle segment 1100 of the mobility staff 1000. The inner handle grip 1150 is intended to provide a comfortable and secure grip for the user during operation. Starting with FIG. 8A, it presents a side view of the inner handle grip. The grip 1550 is designed as a sleeve-like structure that can be slid over the ends of the middle segment 1100 of the staff. It is constructed using a silicone or rubber or similar material known for its durability and ergonomic properties. The inner handle grip features helical ribs (not labeled with reference numerals) that provide enhanced grip and control, even in wet or slippery conditions. Moving to FIG. 8B, which offers a cross-section of the inner handle grip, it provides a more detailed illustration of its design. The figure showcases the cylindrical shape of the grip and highlights the presence of the helical ribs. These ribs are strategically placed along the handle grip's surface to improve grip and prevent slippage during use. They offer a tactile sensation that enhances the user's control and stability when handling the mobility staff. Zooming in on Detail B of FIG. 8B, as depicted in FIG. 8C, we can observe a close-up view of the lip of the grip 1150. The figure highlights the receptacle for raised rib or retention ribs of the middle segment (see FIG. 6). The combined information from FIG. 8A, FIG. 8B, and FIG. 8C provides a comprehensive understanding of the inner handle grip design for the middle segment of the mobility staff. Its sleeve-like structure, use of rubber or similar material, and incorporation of helical ribs ensure a secure and comfortable grip for the user, enhancing the overall usability and control of the staff.

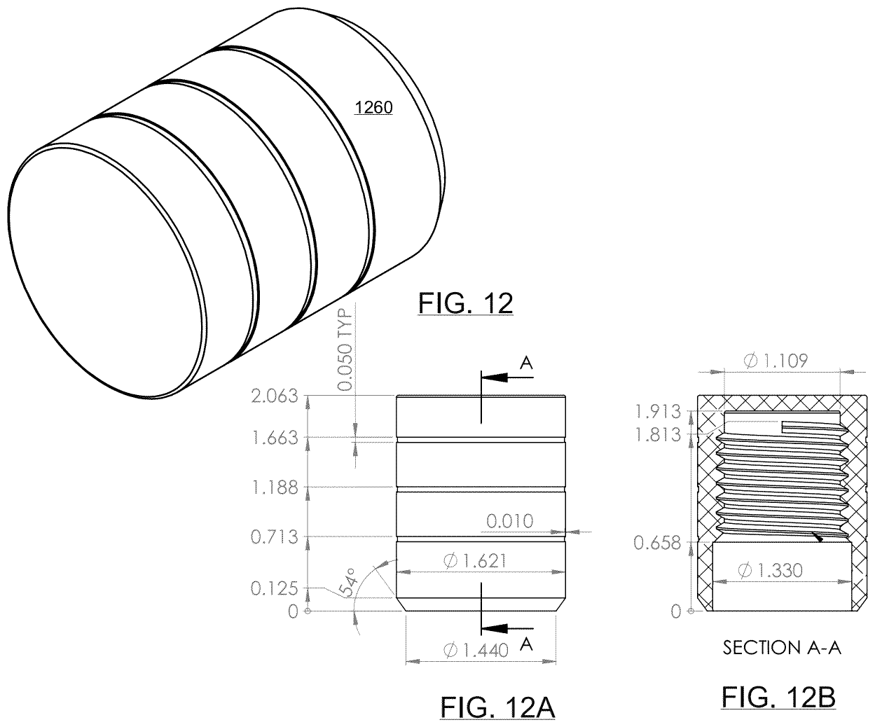

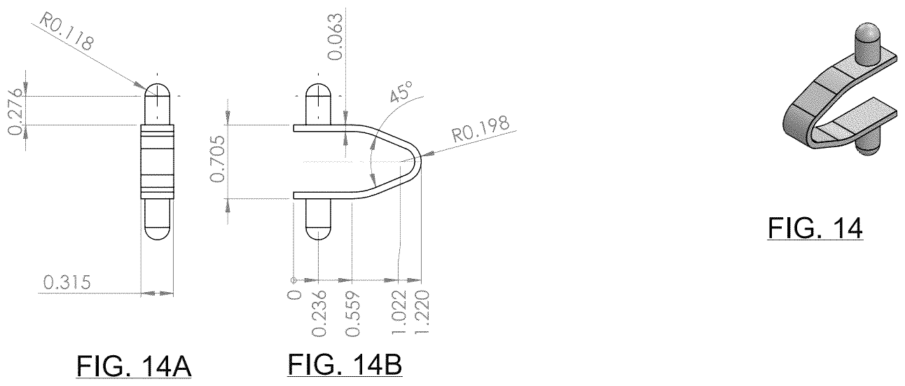

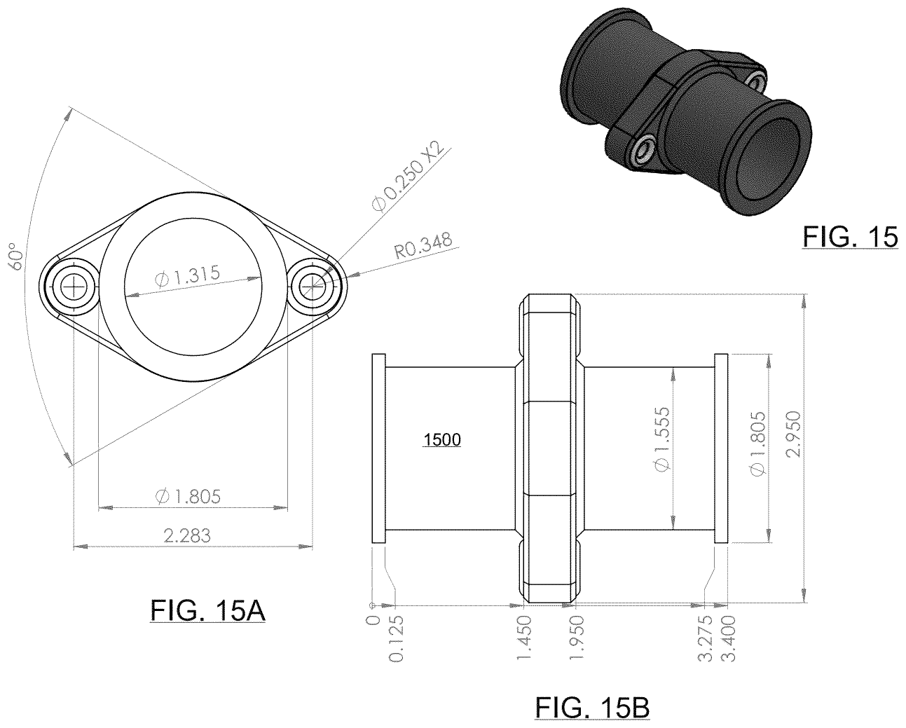

FIG. 11 illustrates the end segment 1200 of the mobility staff 1000, which is designed to be attached to one end of the middle segment (see FIG. 11), providing functionality and structural support. The end segment 1200 consists of several key components, as described below. In FIG. 11, the end segment 1200 is depicted in a perspective view. It features a cylindrical shape with a hollow interior, and it is designed to be coupled with the middle segment 1200. The end segment 1200 includes male threads on one or both ends, which allow for secure attachment to the corresponding female threads of the end cap (shown later in FIG. 12). FIG. 11A presents a side view of the end segment 1200, providing a detailed representation of its structure. The male threads on the end are clearly visible, demonstrating the threaded interface that facilitates the connection with the end cap (see FIG. 12). Moving to FIG. 11B, a cross-section of the end segment along the lines C-C depicted in FIG. 11A is shown. This cross-section highlights the internal structure of the end segment, emphasizing its hollow design. The hollow interior allows for the insertion of the pin head or spring loaded pin (see FIG. 14) for connection with the middle segment, enabling the spring-loaded pin to extend through a hole in the side wall, as described in the earlier discussion. FIG. 11C focuses on the details of the male threads present on the end segment. These threads are specifically designed to mate with the corresponding female threads on the end cap (see FIG. 12), ensuring a secure and robust connection between the end segment and the end cap. Finally, FIG. 11D provides a zoomed-in view of the handle retention rim, which is an important feature for securing the handle grip 1250 on the end segment 1200. The handle retention rim acts as a retaining element, keeping the handle grip 1250 in place and preventing unintended slippage or detachment during use. The combination of the end segment, its male threads, and the handle retention rim allows for a secure attachment of the end cap and handle grip, providing stability and functionality to the mobility staff.

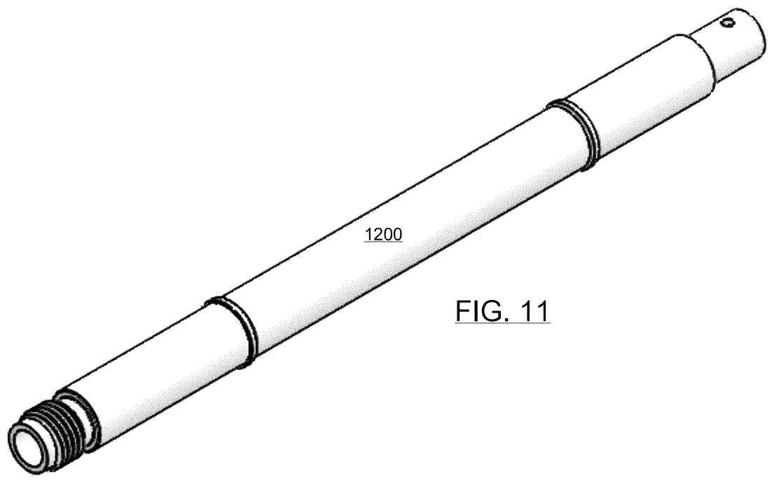

FIG. 12 illustrates the end cap 1260 of the mobility staff, which is designed to be coupled with the end segment 1200 (not shown), providing a secure and functional enclosure for the staffs end and attachment point for the end ball 1220 (not shown). The end cap 1260 consists of several key components, as described below. In FIG. 12, the end cap is shown in a perspective view. It features a circular/cylindrical shape and is designed to fit snugly over the threaded end of the end segment. The end cap 1260 serves multiple purposes, including enclosing the end of the staff, retaining the end ball 1220, providing stability, and facilitating the attachment of the handle grip and anchor. FIG. 12A presents a side view of the end cap 1260, providing a detailed representation of its structure. The end cap 1260 is designed to fit over the male threads of the end segment 1200, with its internal structure coaxially aligned with the staffs hollow interior. The end cap 1260 includes ribs on its outer surface, which are specifically designed to engage with the channels inside the end ball 1120, as shown in FIG. 10D, to securely retain the end ball in place.

FIG. 10A showcases an end cap ball 1220 designed for the end segment of the mobility staff. The end cap ball is a spherical component that is intended to be attached to the end of the staff, providing a protective and functional element. In FIG. 10A, the end cap ball is depicted in a side view. It exhibits a spherical shape. FIG. 10B provides a cross-section of the end cap ball along the line A-A indicated in FIG. 10A. The cross-section reveals the internal structure of the end cap ball, highlighting the presence of a central hole that runs through the ball. This hole is designed to accommodate an end cap, as shown in FIG. 12, allowing for a secure connection between the end cap and the end segment of the staff. Moving to FIG. 10C, it presents a bottom view of the end cap ball. The figure reveals the opening at the bottom of the ball, which aligns with the central hole and serves as an access point for inserting the end cap. FIG. 10D focuses on the details of the channel inside the end ball, which facilitates the coupling between the end ball and the end cap. The channel is designed to receive and engage with corresponding ribs on the end cap, ensuring a secure and stable connection. This configuration prevents unintended detachment and enhances the overall stability and functionality of the staff. The combination of the end cap ball 1220 and the end cap 1260 provides a protective and structurally sound arrangement for the end segment of the mobility staff. The end cap ball's spherical shape, central hole, and channel work in conjunction with the end cap, allowing for easy assembly and disassembly while maintaining a secure connection.

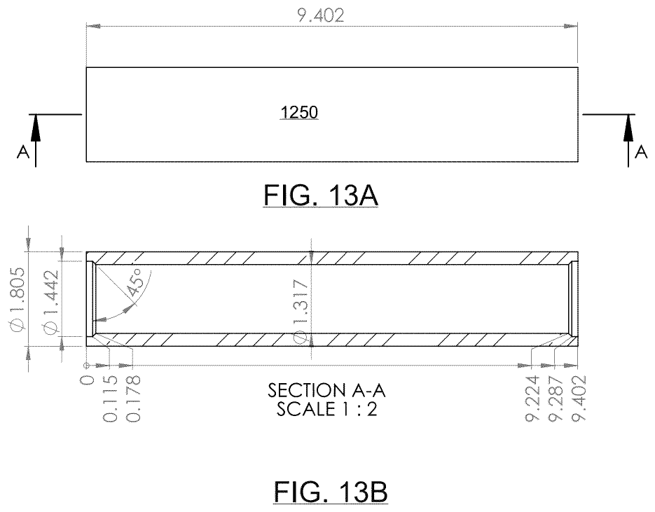

FIG. 13A is a side view of the handle grip 1250 for the end segment 1200 of the staff 1000. FIG. 13B is a cross section of the handle grip 1250 of FIG. 13A along the line A-A in that figure. The handle may be sleeved over the end segment as shown in the earlier figures (see FIGS. 1 through 5). The handle 1250 suitably operates and functions in substantially the same manner as the handle 1150 discussed above.

FIG. 14 showcases the spring loaded pin, which is an essential component of the mobility staff. The spring loaded pin is designed to extend through a hole in the pin head of the end segment, providing a secure connection between the middle segment and the end segment. The pin allows for attachment of end segment while ensuring stability and alignment of the staff. In FIG. 14, the spring loaded pin is presented in a perspective view. It consists of a cylindrical body with a rounded head and a pointed tip. The pin is designed to be inserted into the end of the middle segment, aligning with a corresponding hole in the side wall of the end of the middle segment. The pin is spring-loaded, which allows it to extend and retract as needed. FIG. 14A provides a front view of the spring loaded pin, offering a closer look at its shape and structure. The pin head is located at the top, followed by the cylindrical body extending towards the pointed tip. The pin head is designed to be flush with the outer surface of the end segment when fully inserted, allowing for smooth and uninterrupted movement. Moving to FIG. 146, a side view of the spring loaded pin is depicted, emphasizing its overall length and dimensions. The pin is designed to be of sufficient length to extend through the hole in the pin head of the end segment while providing ample stability and engagement. As the pin extends through the hole in the pin head, it ensures that the end segment remains aligned and engaged, allowing for smooth and controlled movement of the mobility staff.

FIG. 15 illustrates the anchor 1500, an integral part of the mobility staff 1000, which provides stability and support to the various components. The anchor 1500 is designed to be attached to specific locations along the staff and securely hold the adjacent parts in place (including by preventing the parts from sliding coaxially along the staff 1000). In FIG. 15, the anchor 1500 is presented in a perspective view, showcasing its overall structure and design. The anchor 1500 features a slim clip with two grommets that can be easily attached to a carabiner of a resistance band or other suitable attachment points. This allows for the anchor to be positioned and rotated around the staff segment where it is placed, providing flexibility and adjustability. FIG. 15A provides a front view of the anchor, offering a closer look at its shape and configuration. The slim clip is visible, along with the two grommets that are used for attachment. The grommets are designed to securely hold the carabiner or other attachment device, ensuring that the anchor remains firmly in place during use. Moving to FIG. 15B, a side view of the anchor is depicted, emphasizing its streamlined profile. The anchor is designed to be compact and lightweight, allowing for easy attachment and minimal interference with the overall functionality and maneuverability of the staff. Suitably, the anchor 1500 serves as a crucial component in the mobility staff, providing stability and versatility. Its rotatable nature allows for customized positioning and adjustments based on the user's preferences and specific exercise requirements. By securely attaching the anchor to the staff, the resistance band or other accessories can be connected, enabling a wide range of exercises and movements.

Referring back to FIG. 1, the mobility staff 1000 is shown in an assembled state, providing an overview of its components and their arrangement. One of the key elements is the anchor 1500, which plays a crucial role in enabling various exercises and movements. For instance, to attach straps to the grommet of the anchor, the user can follow the following steps:
1: Identify the anchor positioned on the staff segment where desired for the exercise.
2: Take one end of a strap or resistance band and loop it through the grommet of the anchor.
3: Pull the strap or resistance band through the grommet until it is securely attached to the anchor.
4: Repeat the process with the other end of the strap or resistance band, ensuring that both ends are properly attached to the anchor.
5: Adjust the length of the straps or resistance bands based on the desired exercise or movement by either lengthening or shortening the attachment.
6: Once the straps or resistance bands are securely attached to the anchor, the user can grip the handles or hold onto the straps to perform a variety of exercises, such as resistance training, stretching, or mobility drills.
   Suitably, the anchor 1500, with its grommet, provides a reliable attachment point for the straps or resistance bands. This allows the user to incorporate resistance and leverage into their exercises, enhancing the effectiveness and versatility of their workout routine. That said, it is important to note that the specific design and attachment method may vary based on the mobility staffs construction and the type of straps or resistance bands being used. The instructions provided here are a general guideline, and users should always refer to the manufacturer's recommendations and exercise guidelines for proper usage and safety precautions.
   Referring again to FIG. 1, one can describe how a user can position the mobility staff to perform massage therapy by leaning into the other end ball while one end ball is placed in a corner or gridlock. Here's a step-by-step description:
1. Begin by identifying one of the end balls of the mobility staff, which is designed to provide a rounded surface for massage therapy.
2. Locate a suitable corner or gridlock area where you can position the end ball securely. This can be a corner of a wall, a stable surface, or any other fixture that can hold the end ball in place.
3. Place the rounded end ball into the corner or gridlock area, ensuring that it fits securely and is stable.
4. Adjust the position of the staff so that the end ball remains fixed in the desired location.
5. With the end ball secured, position yourself in front of the mobility staff, facing away from the corner or gridlock area.
6. Lean into the other end ball of the staff, applying pressure against your shoulder or any other desired area for massage therapy.
7. Adjust the intensity of the massage by varying the amount of pressure you apply and the angle at which you lean into the staff.
8. Move your body and the staff in a controlled manner to target different muscle groups or areas that require massage therapy.
9. Engage in slow, deliberate movements and adjust your positioning as needed to achieve the desired massage effect.
10.As you lean into the staff, the rounded end ball provides a smooth and comfortable surface that can help alleviate muscle tension and promote relaxation.

It's important to note that the mobility staff's design allows for versatility in performing various exercises and therapeutic activities. The ability to position one end ball in a corner or gridlock while leaning into the other end ball provides a unique massage therapy experience, allowing users to target specific areas and adjust the pressure according to their preferences.

Here are some exercises you can perform with the staff 1000 when resistance bands are attached to the anchor points:

Banded Chest Press: Attach the resistance bands to the anchor points on either side of the stick. Hold the stick horizontally at chest level with an overhand grip, palms facing forward. Step back to create tension in the bands. Push the stick forward until your arms are fully extended, and then slowly bring it back to the starting position. This exercise targets the chest, shoulders, and triceps.

Banded Rows: Attach the resistance bands to the anchor points on either side of the stick. Stand with your feet shoulder-width apart and hold the stick in front of you with an overhand grip. Step back to create tension in the bands. Pull the stick toward your body, keeping your elbows close to your sides, and squeeze your shoulder blades together. Slowly return to the starting position. This exercise targets the back, shoulders, and biceps.
Banded Squats: Place the stick horizontally across your shoulders behind your neck, holding onto the ends. Step on the resistance bands, creating tension. Perform squats by bending your knees, lowering your hips down and back as if sitting into a chair, and then pushing through your heels to stand up straight. The bands provide resistance, targeting your quadriceps, hamstrings, and glutes.
Banded Lateral Raises: Stand with your feet shoulder-width apart, and hold the staff horizontally in front of you with an overhand grip. Attach the resistance bands to the anchor points on either side of the stick. Step back to create tension in the bands. Raise the stick out to the sides until your arms are parallel to the floor, and then slowly lower it back down. This exercise targets the shoulders and upper back.
Banded Rotational Twists: Attach the resistance bands to the anchor points on either side of the stick. Hold the stick with both hands at chest level, and step back to create tension in the bands. Rotate your torso to one side while keeping your hips facing forward, and then return to the starting position. Repeat on the other side. This exercise engages your core muscles and improves rotational strength.

Terms and phrases used in this document, and variations thereof, unless otherwise expressly stated, should be construed as open-ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more,” or the like; and adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

The staff takes customization and adaptability to the next level with its innovative design and interchangeable components. This fitness tool consists of three segments, each offering unique functionalities and configurations. Let's explore the enhanced features of the staff:

Three-Segment Structure: The staff is composed of three distinct segments—two end segments and a middle segment. This tri-segment structure allows for convenient assembly and disassembly, providing flexibility in configuring the stick to suit your specific needs.
Interchangeable Balls: The end segments of the stick feature a distal end that allows for the attachment of balls. These balls can have a hole, either partially or fully through, for easy attachment. The interchangeable balls provide versatility in terms of size and texture, enabling you to personalize your massage experience and target different muscle groups effectively. In some cases the balls could be made of Polyurethane or Polyurothran material to create an accommodation to areas massaged that may be pointy or uncomfortable due to the nature of the anatomy. Such materials create a tissue drage and can absorb pressure superior to a hard rubber, wooden, or plastic ball.
Threaded Connections: The end segments of the stick are equipped with male threads, while the middle segment has a corresponding female thread. This threaded connection ensures a secure and stable attachment between the segments, allowing for seamless transitions and avoiding any unwanted loosening during use.
Customizable Configuration: With the staff, you have the freedom to configure the stick in various ways. You can choose to attach one or multiple balls on each end segment, allowing for a diverse range of massage techniques and intensities. Additionally, the middle segment's length can be adjusted based on your preference and specific application, providing a tailored experience. The ability of the mobility stick to break down into smaller piece creates an advantage by making it more portable and less cumbersome with travel and storage.
Exercise and Resistance Training: The staff retains its original functionality for resistance training. The anchor points on the end segments, along with the threaded connection, still allow for the attachment of resistance bands. This feature provides a comprehensive workout experience by incorporating resistance exercises and muscle strengthening routines into your fitness regimen.
The staff represents the pinnacle of versatility and customization, catering to both exercise enthusiasts and those seeking muscle pain relief and massage therapy.

Additionally, the various embodiments set forth herein are described in terms of exemplary block diagrams, flow charts, and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

1. A mobility staff comprising
a middle segment and two end segments;
wherein each end segment features an end ball, an anchor, and a handle grip;
wherein the middle segment is designed to receive the pin heads of the end segments, allowing for secure attachment;
wherein the middle segment roller balls, inner and outer handle grips, anchors, and retention rims.

2.
